(19) United States
(12) Patent Application Publication
(10) Pub. No.: US 2025/0015942 A1
(43) Pub. Date: Jan. 9, 2025

(54) DOWNLINK SCHEDULING FOR INCREASED ORTHOGONAL DMRS PORTS AND PRB BUNDLING SIZE

(71) Applicant: QUALCOMM Incorporated, San Diego, CA (US)

(72) Inventors: Pinar SEN, San Diego, CA (US); Muhammad Sayed Khairy ABDELGHAFFAR, San Jose, CA (US); Yi HUANG, San Diego, CA (US); Alexandros MANOLAKOS, Athens (GR)

(21) Appl. No.: 18/708,188

(22) PCT Filed: Dec. 15, 2022
(86) PCT No.: PCT/US2022/053079

§ 371 Date: May 7, 2024

(30) Foreign Application Priority Data
Jan. 26, 2022 (GR) 20220100068

(51) Int. Cl. H04L 5/00; H04W 72/232

(52) U.S. Cl. CPC H04L 5/0023; H04L 5/0051; H04W 72/232

(57) ABSTRACT

Method and apparatus for downlink scheduling for increased orthogonal DMRS ports and PRB bundling size. The apparatus transmits DCI comprising an antenna value associated with a DMRS port mapping configuration. The DMRS port mapping configuration comprising orthogonal codes over a frequency domain and an orthogonal code sequence having a length (N) of orthogonal codes applied in the frequency domain. The orthogonal code sequence having a value of N>2. The apparatus transmits an indication comprising a DMRS port ID field associated with the DMRS port mapping configuration. At least one of the DMRS port ID field, the orthogonal code sequence, or the antenna value configured to identify a DMRS port.

### CROSS-REFERENCE TO RELATED APPLICATION

This application claims the benefit of Greece patent application No. 20220100068, entitled “DOWNLINK SCHEDULING FOR INCREASED ORTHOGONAL DMRS PORTS AND PRB BUNDLING SIZE” and filed on Jan. 26, 2022, which is expressly incorporated by reference herein in its entirety.

### TECHNICAL FIELD

The present disclosure relates generally to communication systems, and more particularly, to a configuration for downlink scheduling for increased orthogonal demodulated reference signals (DMRS) ports and physical resource block (PRB) bundling size.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus may transmit downlink control information (DCI) comprising an antenna value associated with a demodulation reference signal (DMRS) port mapping configuration. The DMRS port mapping configuration comprising orthogonal codes over a frequency domain and an orthogonal code sequence having a length (N) of orthogonal codes applied in the frequency domain. The orthogonal code sequence having a value of N>2. The apparatus may transmit an indication comprising a DMRS port identifier (ID) field associated with the DMRS port mapping configuration. At least one of the DMRS port ID field, the orthogonal code sequence, or the antenna value configured to identify a DMRS port.

In an aspect of the disclosure, a method, a computer-readable medium, and an apparatus are provided. The apparatus may be a device at a base station. The device may be a processor and/or a modem at a base station or the base station itself. The apparatus may configure a physical resource block (PRB) bundling type comprising bundle sizes of sub-resource block (RB), 1 RB, or 8 RBs. The apparatus may transmit downlink control information (DCI) comprising a PRB bundling size indicator.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A illustrates an example of port mapping for a first configuration with one symbol.

FIG. 4B illustrates an example of port mapping for a first configuration with two symbols.

FIG. 5A illustrates an example of port mapping for a second configuration with one symbol.

FIG. 5B illustrates an example of port mapping for a second configuration with two symbols.

FIG. 6 illustrates an example of port mapping for a first configuration.

FIG. 7 illustrates an example of an increased code length.

FIG. 8 illustrates an example of port mapping for a first configuration.

FIG. 9 illustrates an example of port mapping for a second configuration.

FIG. 10 illustrates an example of port mapping for a single symbol.

FIG. 11 illustrates an example of port mapping for double symbols.

FIG. 12 illustrates an example of port mapping for double symbols.

FIG. 13 illustrates an example of a first configuration with 1 DMRS symbol.

FIG. 14 illustrates an example of an increased amount of ports for a first configuration with 1 DMRS symbol.

FIG. 15 illustrates an example of a first configuration with 2 DMRS symbols.

FIG. 16 illustrates an example of an increased amount of DMRS ports.

FIG. 17A illustrates an example of PRB static bundling.

FIG. 17B illustrates an example of PRB dynamic bundling.

FIG. 17C illustrates an example of PRB dynamic bundling.

FIG. 18 is a call flow diagram of signaling between a UE and a base station.

FIG. 19 is a flowchart of a method of wireless communication.

FIG. 20 is a flowchart of a method of wireless communication.

FIG. 21 is a diagram illustrating an example of a hardware implementation for an example apparatus.

FIG. 22 is a call flow diagram of signaling between a UE and a base station.

FIG. 23 is a flowchart of a method of wireless communication.

FIG. 24 is a flowchart of a method of wireless communication.

FIG. 25 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

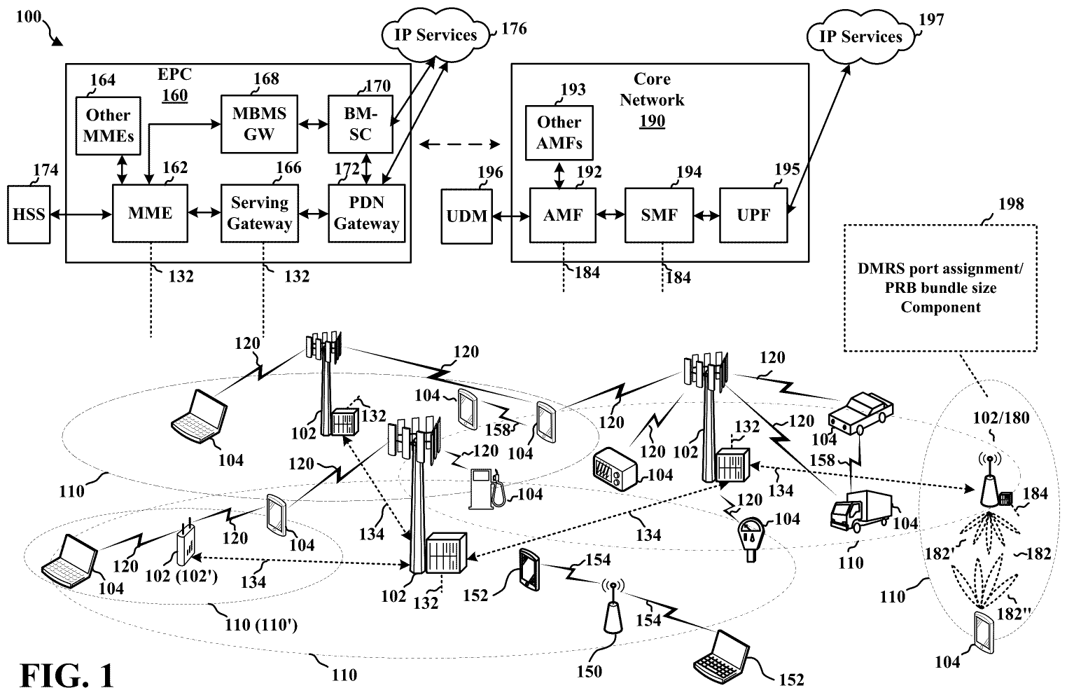

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHZ). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the base station 180 may be configured to provide an indication of a DMRS port assignment or a PRB bundle size via DCI. For example, the base station 180 may comprise a DMRS port assignment/PRB bundle size component 198 configured to provide an indication of a DMRS port assignment or a PRB bundle size via DCI.

Although the following description may be focused on 5G NR, the concepts described herein may be applicable to other similar areas, such as LTE, LTE-A, CDMA, GSM, and other wireless technologies.

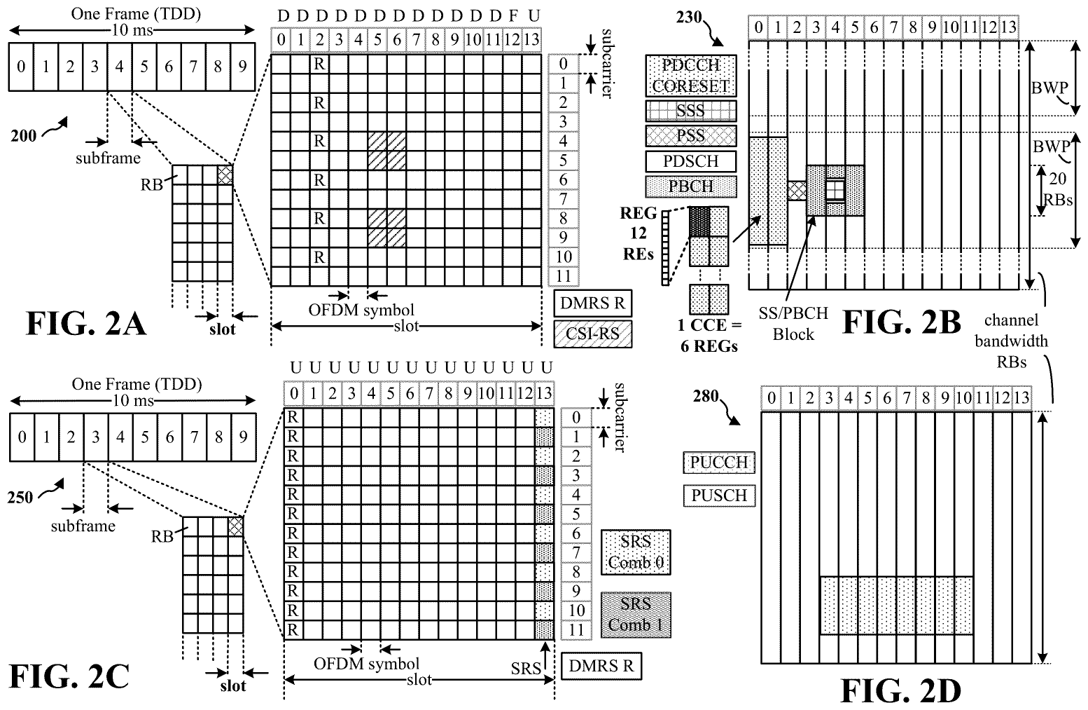

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

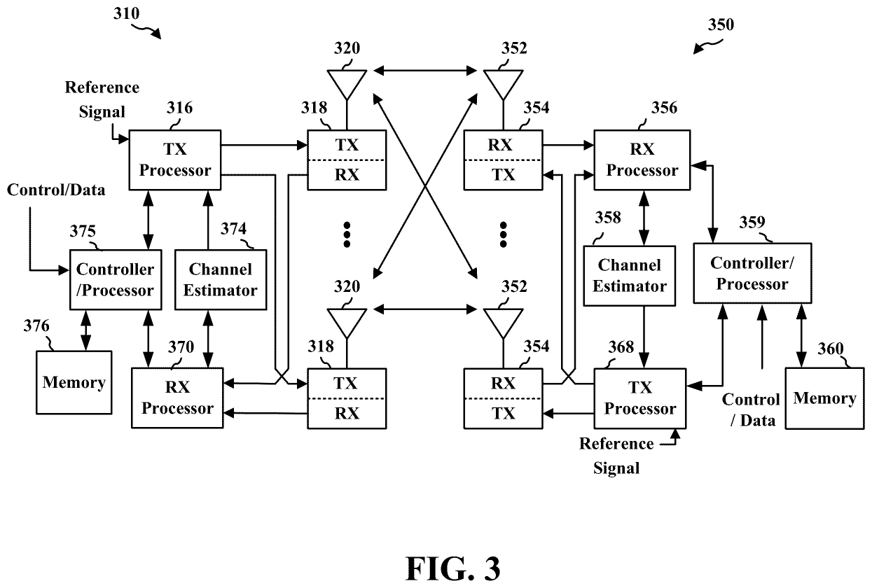

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 316, the RX processor 370, and the controller/processor 375 may be configured to perform aspects in connection with 198 of FIG. 1.

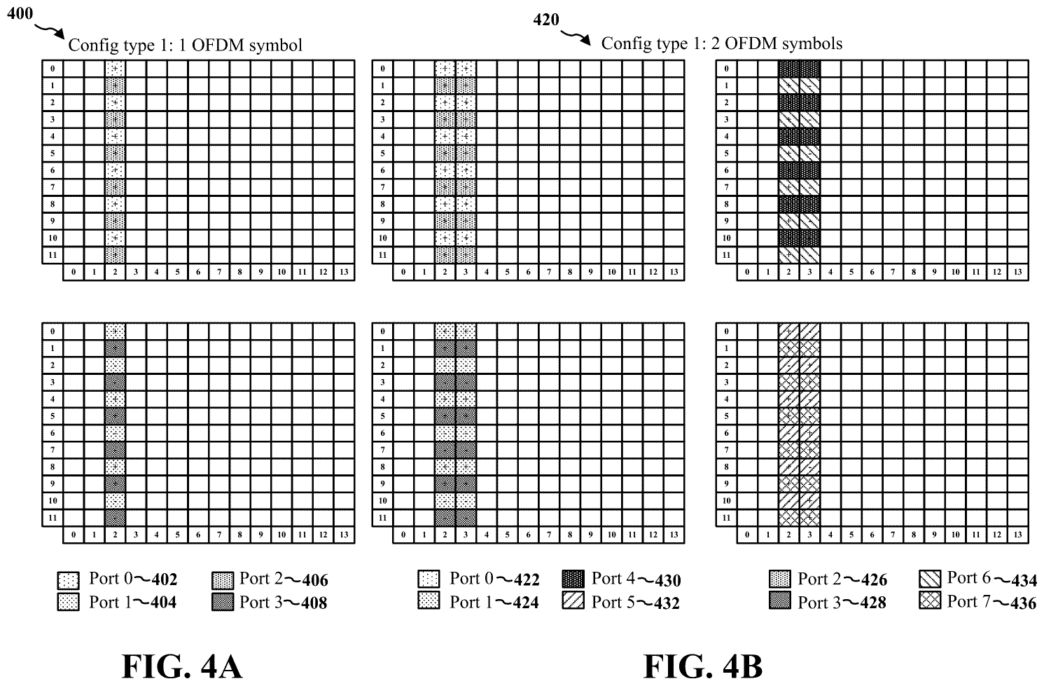

In wireless communications, UEs may comprise up to 4 receive antennas, such that base station may transmit up to 4 downlink layers to the UEs. DMRS configuration may comprise two configurations a first configuration may support up to 8 DMRS ports with 2 DMRS symbols, and a second configuration may support up to 12 DMRS ports with 2 DMRS symbols. The first configuration may comprise up to 8 DMRS ports based on 2 frequency domain orthogonal covering codes, a comb 2 structure, and 2 time domain orthogonal covering codes. For example, with reference to diagram 400 of FIG. 4A, the first configuration, using 1 OFDM symbol may support 4 DMRS ports (e.g., port 0 402, port 1 404, port 2 406, and port 3 408). Port 0 402 and port 1 404 may use the same frequency resources, but are separated based on the orthogonal covering codes. Port 2 406 and port 3 408 may use the same frequency resources, but are also separated based on the orthogonal covering codes. With reference to diagram 420 of FIG. 4B, the first configuration, using 2 OFDM symbols may support 8 DMRS ports (e.g., port 0 422, port 1 424, port 2 426, port 3 428, port 4 430, port 5 432, port 6 434, port 7 436). Ports may use the same frequency resources, but may be separated based on the orthogonal covering codes. For example, port 0 422 and port 1 424 may use the same frequency resources, but are separated by the orthogonal covering code. The pair of ports port 2 426 and port 3 428, port 4 430 and port 5 432, and port 6 434 and port 7 436 may, respectively, use the same frequency resources, but are separated by the respective orthogonal covering code.

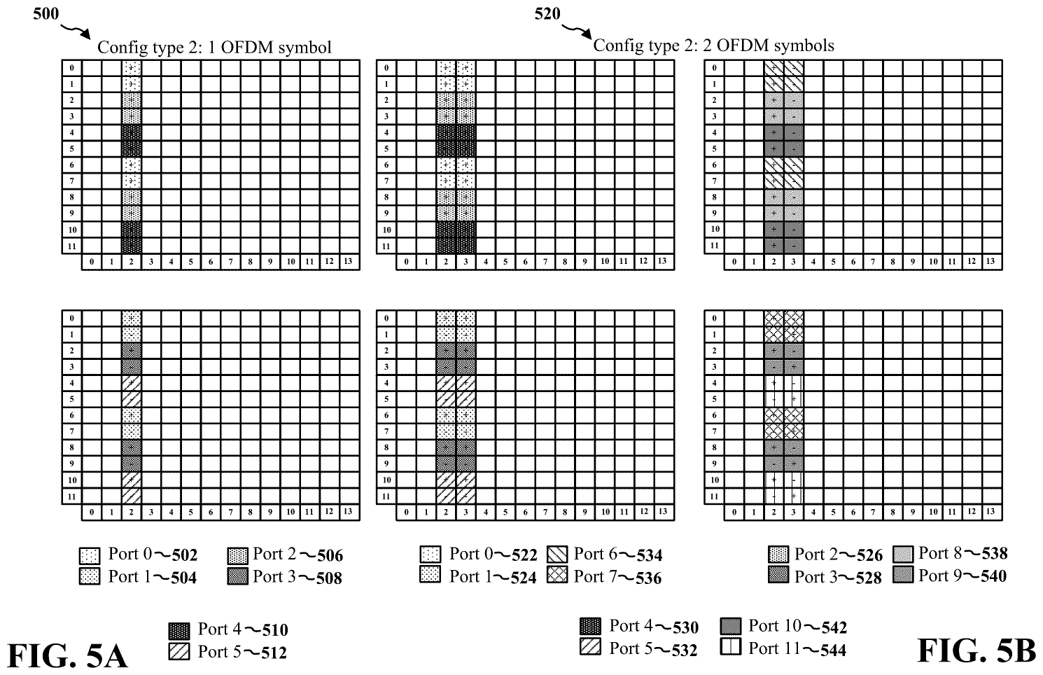

The second configuration may support up to 12 DMRS ports based on 2 frequency domain orthogonal covering codes, an offset value of 3, and 2 time domain orthogonal covering codes. For example, with reference to diagram 500 of FIG. 5A, the second configuration, using 1 OFDM symbol may support 6 DMRS ports (e.g., port 0 502, port 1 504, port 2 506, port 3 508, port 4 510 and port 5 512). With reference to diagram 520 of FIG. 5B, the second configuration, using 2 OFDM symbols may support 12 DMRS ports (e.g., port 0 522, port 1 524, port 2 526, port 3 528, port 4 530, port 5 532, port 6 534, port 7 536, port 8 538, port 9 540, port 10 542, and port 11 544). As discussed above, ports that use the same frequency resources are separated based on the orthogonal covering code.

In some instances, UEs (e.g., premium UEs) may comprise an increased amount of receive antennas, which may allow for base stations to transmit an increased amount of downlink layers. For example, UEs (e.g., premium UEs) may comprise more than 4 receive antennas, such that base stations may transmit more than 4 downlink layers to the premium UEs. In such instances, 4 DMRS symbols may be utilized for medium Doppler, where two DMRS symbols are front loaded and two additional positions. Increasing the amount of downlink layers may increase the signaling overhead which may cause a reduction in spectral efficiency. In addition, transmitting more than 4 downlink layers may result in a need for an improved Rnn estimation. As such, an increase in the number of orthogonal DMRS ports may lead to a reduction in DMRS overhead. The number of orthogonal DMRS ports may be increased by increasing the code depth in the frequency domain to multiplex more ports.

Aspects presented herein provide a configuration of providing a DCI indication associated with a DMRS port mapping configuration having the increased number of DMRS ports based on the increase of the code depth. At least one advantage of the disclosure is that the increase of the DMRS ports may support downlink reception of more than 4 downlink layers from base stations. In addition, the increase of DMRS ports may also enhance spectral efficiency by reducing DMRS overhead.

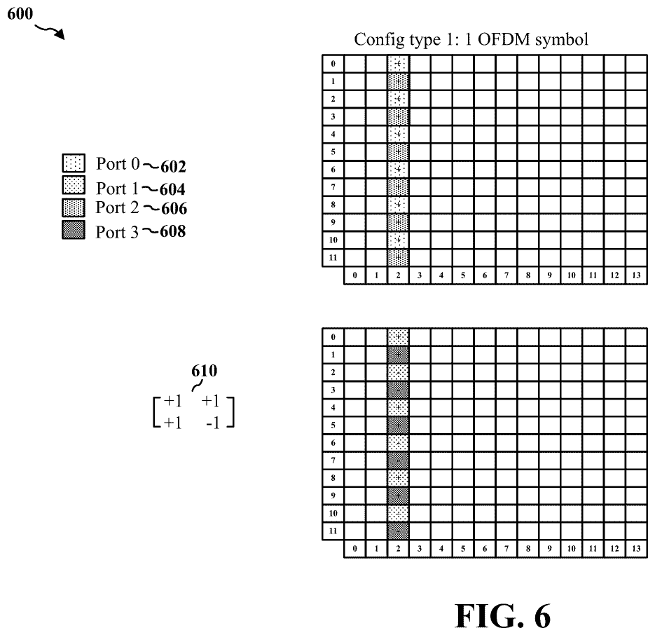

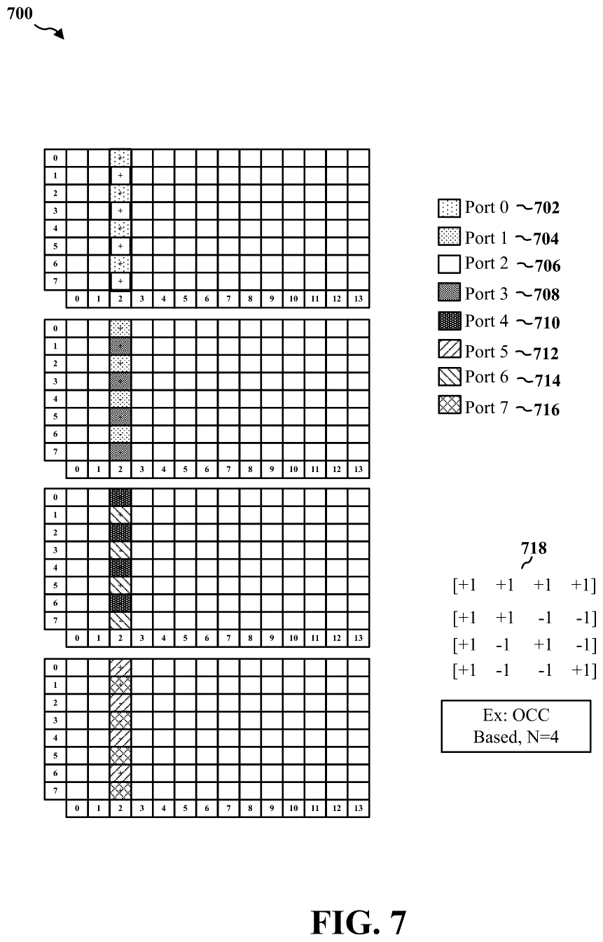

The increase of the number of orthogonal ports may be based on an increase of the code depth in the frequency domain, which may allow for more port to be multiplexed. For example, with reference to diagram 600 of FIG. 6, the first configuration, using one OFDM symbol, may comprise four DMRS ports (e.g., port 0 602, port 1 604, port 2 606, and port 3 608) based on a code length 610 of 2. The orthogonal codes may be utilized to multiplex the ports in the same frequency resources in the same comb. With reference to diagram 700 of FIG. 7, the code length 718 may be increased to a value of 4, for example, which is greater than the code length 610 of diagram 600, such that more ports may be multiplexed together based on the increased code length 718. In the aspect of diagram 700, the code length 718 is increased to the value of 4, which provides 8 ports (e.g., port 0 702, port 1 704, port 2 706, port 3 708, port 4 710, port 5 712, port 6 714, and port 7 716). In some aspects, the orthogonal codes may be based on orthogonal covering codes (OCC) or cyclic shift. The number of ports supported may be based on the code length (N) such that the combination of the code length (N) in the frequency domain, the comb structure having a value of 2 or 3, and 2 time domain orthogonal covering codes.

The addition of orthogonal codes or increasing the code length may support more ports per symbol. As shown in diagram 600 of FIG. 6 has 2 ports per comb per symbol with a code length 610

$$[ \begin{matrix}+ 1 & + 1 \\ + 1 & - 1\end{matrix} ]$$

that maps to cyclic shifts of exp(j0) and exp(jπ). For N ports per comb per symbol, within each comb the phase shifts of exp(jαᵢn) may be applied to every n^{th} entry of a group of N resources for n=0, 1, . . . , N−1. Port naming may be backwards compatible by using the following equation to determine αᵢ:

$${α}_{i} = \frac{2 π}{N} {t}_{i} + {m}_{i} π ,$$

where (pᵢ−1000)=4 (DMRS type+1)*tᵢ+mᵢ, for port id p_i {1000, 1001, 1002, . . . },
tᵢ: largest integer divisor, and
mᵢ: remainder.

For a double symbol, the same cyclic shift may be used in the time domain and apply a time domain orthogonal code for spreading over time. Assigning a different cyclic shift to different ports, such that only the port assignment is different to account for the backward compatibility.

In some instances, an increase of the length of the frequency domain orthogonal codes may support more ports per symbol. As shown in diagram 600 of FIG. 6 has 2 ports per comb per symbol with a code length 610

$$[ \begin{matrix}+ 1 & + 1 \\ + 1 & - 1\end{matrix} ]$$

that maps to the rows of a Hadamard matrix of size 2×2. The rows of the Hadamard matrix of size N×N may be applied within each comb, for N ports per comb per symbol. Port mapping may be backwards compatible by using the following equation to determine αᵢ:

$${α}_{i} = 2 {t}_{i} + 1 + mod\_ 2 ( {m}_{i} ) ,$$

where (pᵢ−1000)=4 (DMRS type+1)*tᵢ+mᵢ, for port id {1000, 1001, 1002, . . . }
tᵢ: largest integer divisor, and
mᵢ: remainder.

F a double symbol, the same time domain orthogonal covering code may be spread over time, similar as described above for cyclic shift based sequences.

The generalization of port indexing may be based on

$${a}_{k , l}^{( p , μ )} = {β}_{PDSCH}^{DMRS} {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

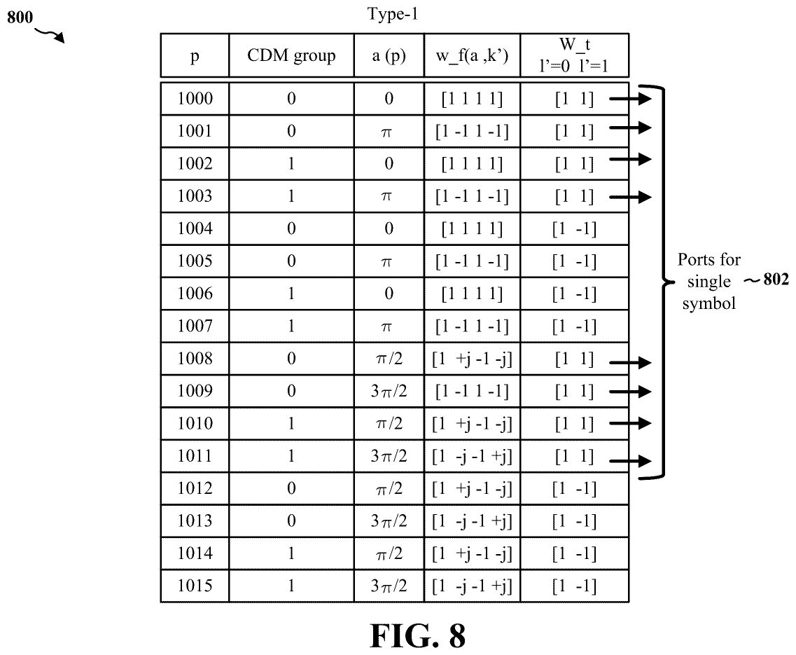

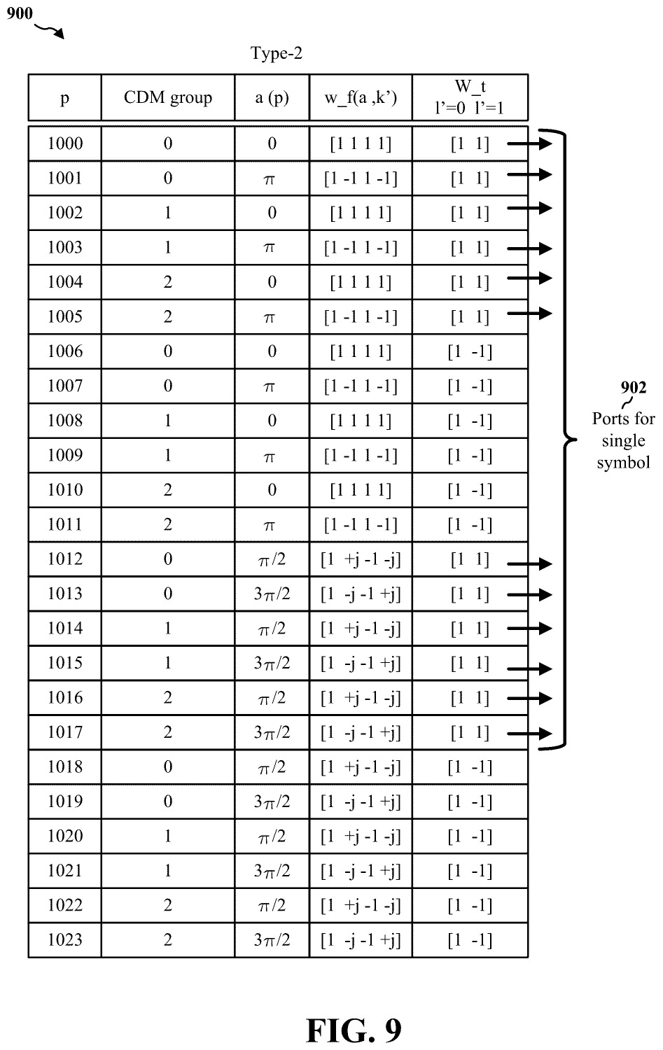

for a length of N=2 code over frequency (e.g., w_f(k′): k′=0 or =1). Increasing the length such that N>2, the methodology to generalize the tables associated with parameters for DMRS first or second configuration for an arbitrary N may result in changing w_f(k′) to w_f(α,k′). For example, w_f(α,k′) may correspond to [exp(j2π/Nα(p)k′)]_{k′=0, 1, . . . , (N−1)} for cyclic shift or may correspond to (α, k′) element of N×N Hadamard matrix for Walsh sequences. With reference to diagram 800 of FIG. 8, for N=4 for cyclic shift, the first configuration may support 16 ports, while the ports for single symbol 802 may be utilized to preserve backward compatibility. With reference to diagram 900 of FIG. 9, for N=4 for cyclic shift, the second configuration may support 24 ports, while the ports for single symbol 902 may be utilized to preserve backward compatibility. The ports corresponding with π/2 or 3π/2, in diagram 800 and 900, may be the additional ports that are added, such that the total number of ports are doubled.

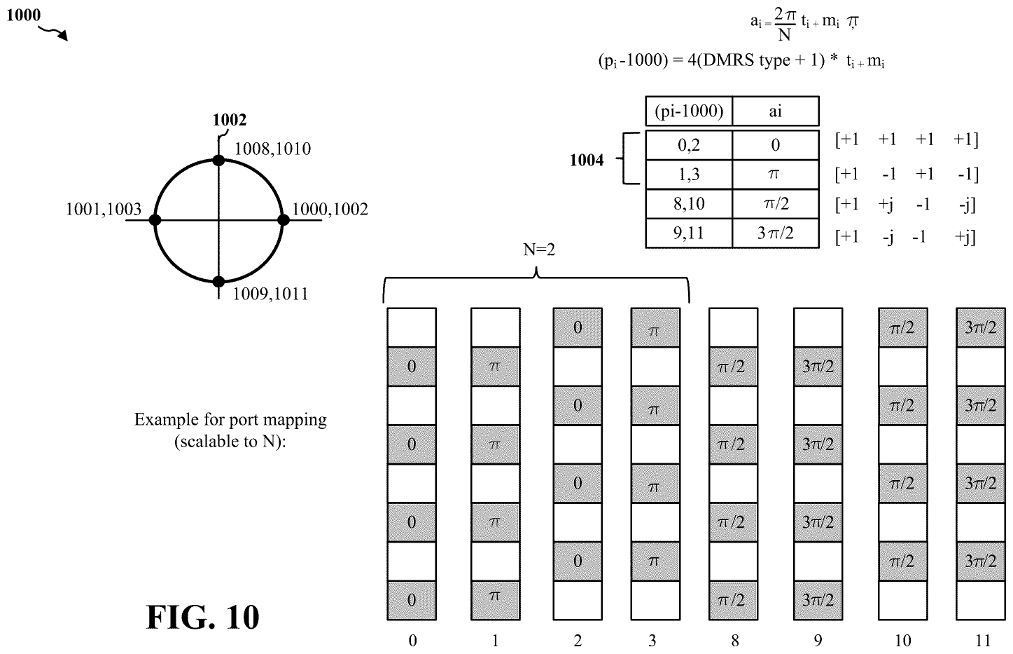

FIG. 10 provides a diagram 1000 of an example of port mapping for a single symbol. In some instances, for example, N=4 cyclic shifts, a single symbol in the first configuration may support 8 ports in total. To maintain backwards compatibility, ports 0-3 remain in their current location (e.g., 0, π) of graph 1002. The group 1004 of ports 0-3 maintain the same parameters to maintain the same port mapping. The new ports (e.g., 1008, 1009, 1010, 1011) shown in graph 1002 have a location corresponding with π/2 or 3π/2. For example, the phase of port 1008 is assigned the cyclic shift of π/2 and the sequence of [+1 +j −1 −j] is used in the frequency domain to transmit the DMRS. In another example, the phase of port 1009 is assigned the cyclic shift of 3π/2 and the sequence of [+1 −j −1 +j] is used in the frequency domain to transmit the DMRS.

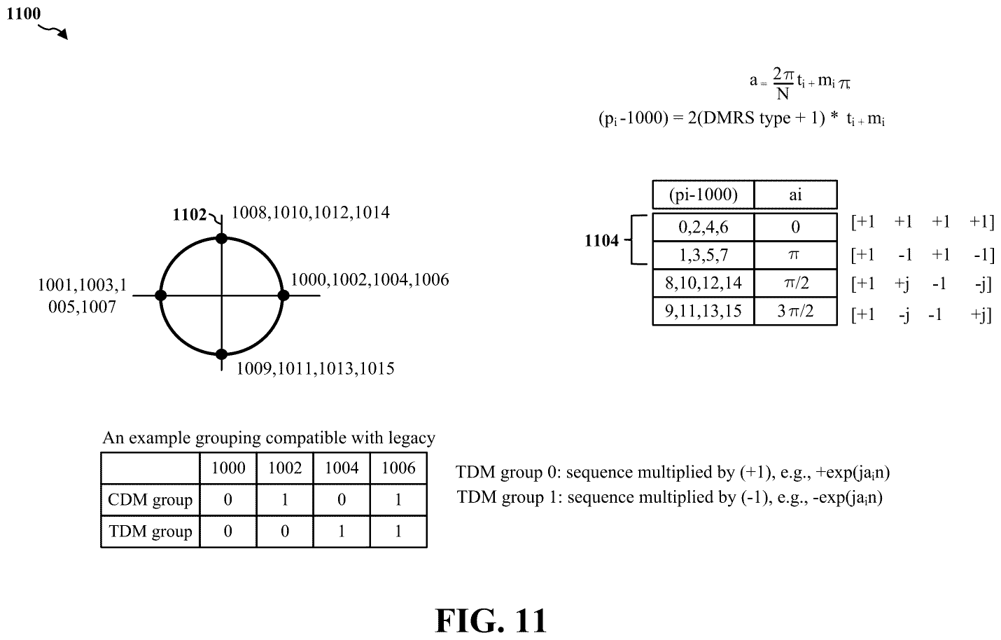

FIG. 11 provides a diagram 1100 of an example of port mapping for double symbols (e.g., 2 symbols in time domain). In some instances, for example, N=4 cyclic shifts, double symbols in the first configuration may support 16 ports in total. To maintain backwards compatibility, ports 0-7 remain in their current location (e.g., 0, π) of graph 1102. The group 1104 of ports 0-7 maintain the same parameters to maintain the same port mapping. The new ports (e.g., ports 1008-1015) shown in graph 1102 have a location corresponding with π/2 or 3π/2. For example, the phase of port 1008 is assigned the cyclic shift of π/2 and the sequence of [+1 +j −1 −j] is used in the frequency domain to transmit the DMRS. In another example, the phase of port 1009 is assigned the cyclic shift of 3π/2 and the sequence of [+1 −j −1 +j] is used in the frequency domain to transmit the DMRS. For double symbol, within each cyclic shift, ports may be grouped into CDM and TDM such that backward compatibility mapping is preserved. For example, TDM group 0 may comprise a sequence multiplied by +1, e.g., +exp(jαᵢn). TDM group 1 may comprise a sequence multiplied by −1, e.g., −exp(jαᵢn).

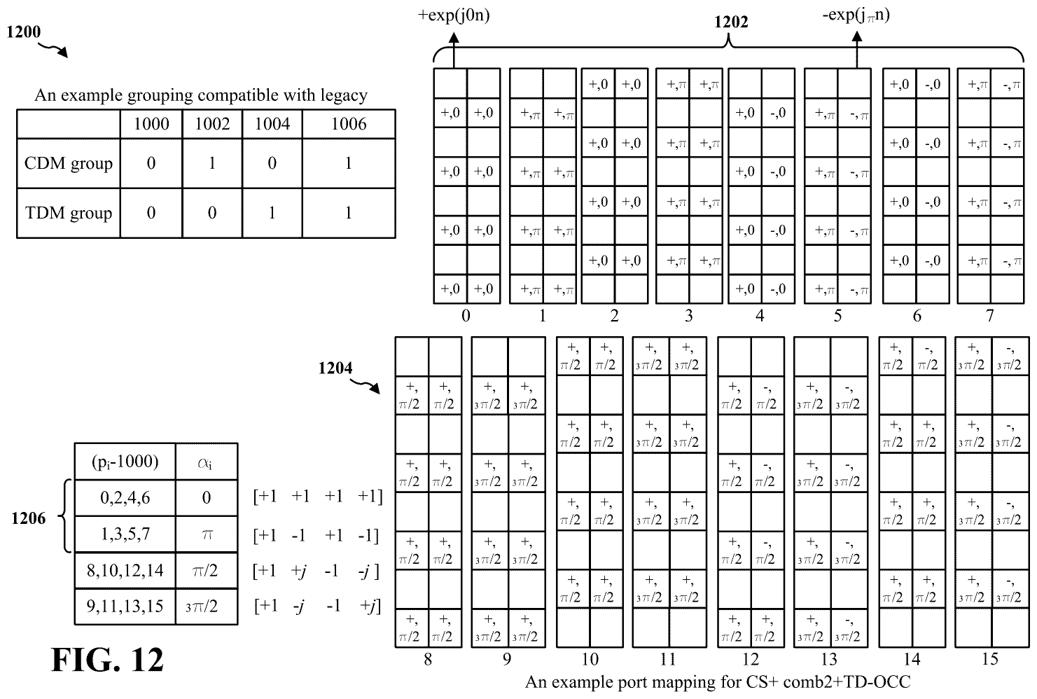

FIG. 12 provides a diagram 1200 of an example of port mapping for double symbols. In some instances, for example, N=4 cyclic shifts, double symbols in the first configuration may support 16 ports in total. The group 1202 of ports (e.g., ports 0-7) may be configured to maintain backwards compatibility, while the group 1204 of ports (e.g., ports 8-15) may comprise the new additional groups. The group 1204 of ports may correspond to a mapping based on cyclic shift, a comb sequence having a value of 2, and time domain orthogonal covering codes.

With regards to the selection and indication of the value of N, a maximum delay spread resolution may assist in maintaining orthogonality between ports. The maximum delay spread may be less than 1/[(subcarrier spacing)×N×(comb sequence value)]. The value of N should be chosen to satisfy the inequality; otherwise interference may be present across ports. With regards to an indication sent to a UE (e.g., alpha→cyclic shift), the base station may determine how to assign ports to different UEs based on the cyclic shift. The port identifier (ID) may determine the cyclic shift. For example, the base station may indicate the port ID or the cyclic shift within an antenna field within DCI. In some aspects, based on the number of layers available at a UE, the base station may assign either multiple cyclic shifts within the same CDM group, or multiple CDM groups and less cyclic shifts. The base station may determine the value of N and provide an indication of the value of N via DCI.

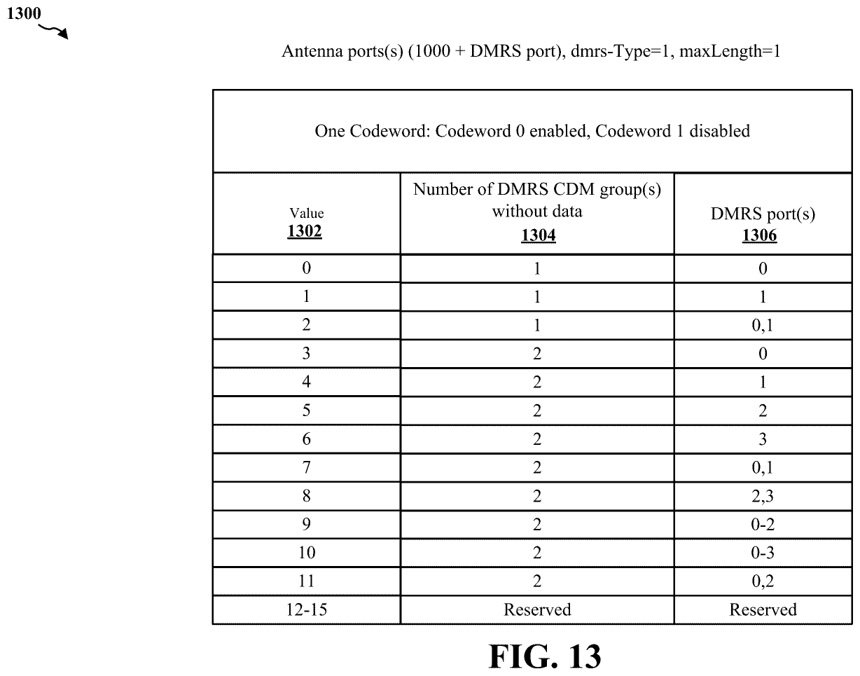

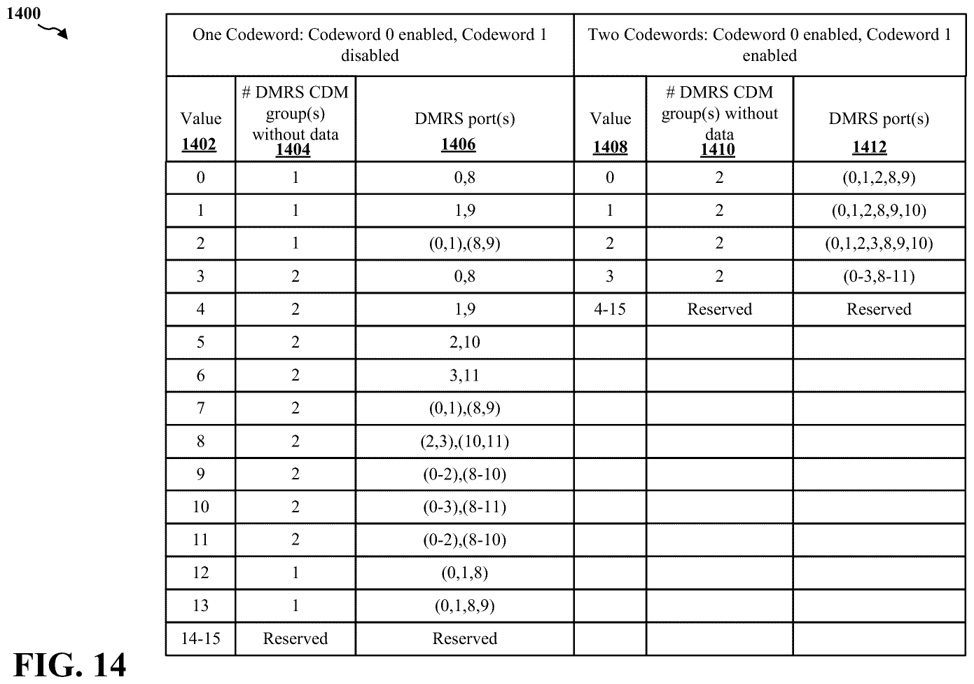

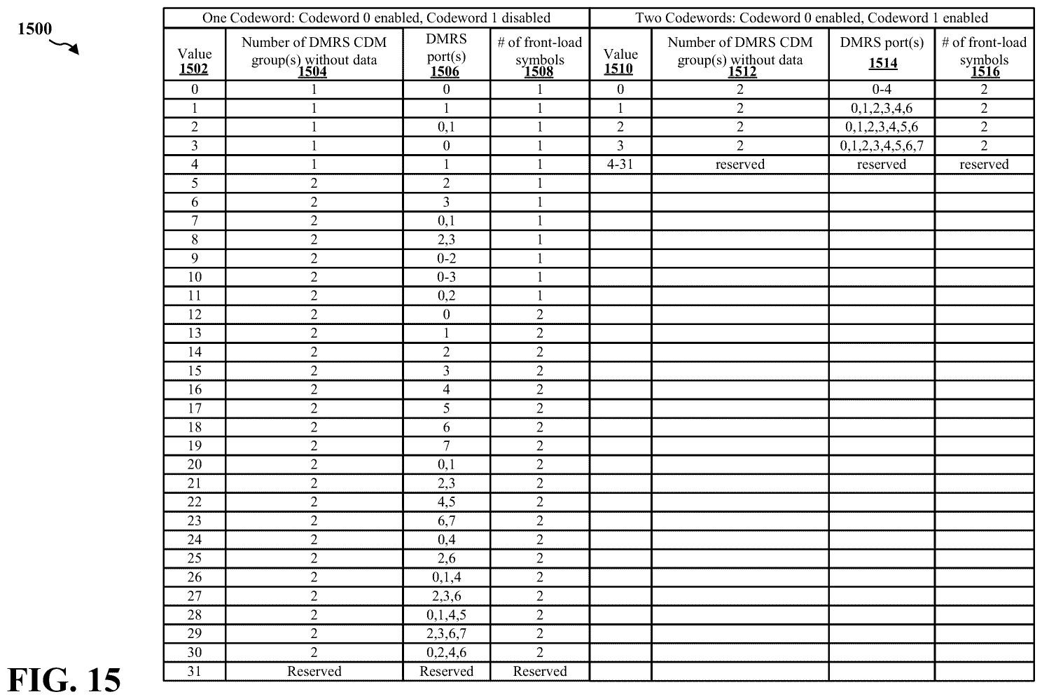

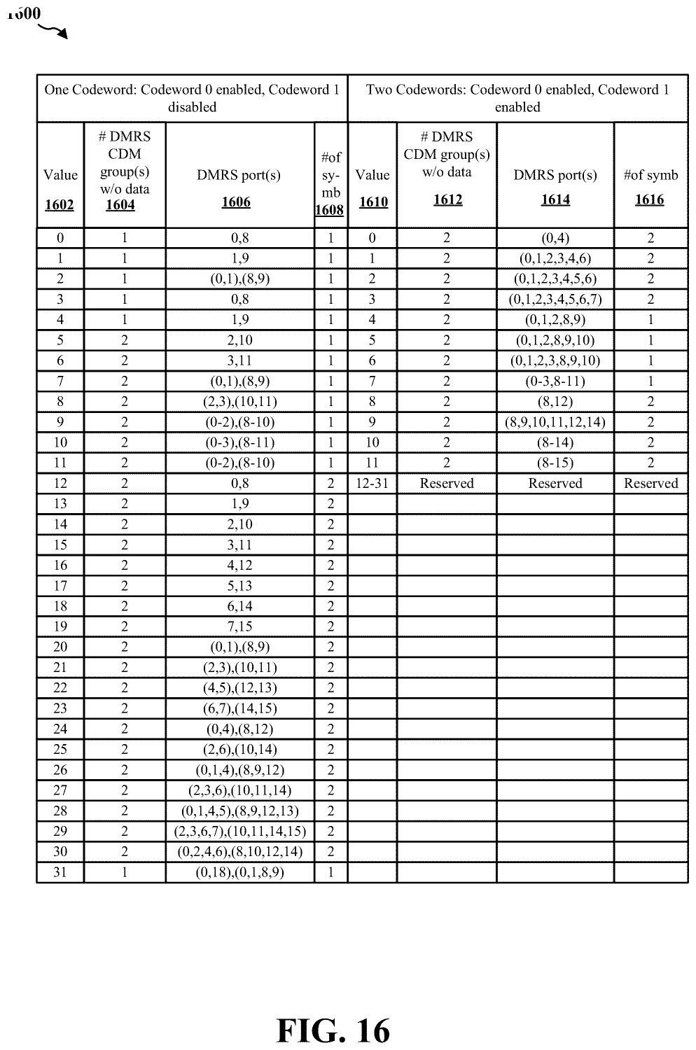

DMRS ports assignment may be indicated in the antenna ports filed of DCI format 1_1. The indication of the port assignment may be updated or modified in response to increasing the number of DMRS ports. In some aspects, adding more values within the antenna ports field of DCI may allow for the indication to identify the port assignment of the increased number of ports. In some aspects, DCI overhead is not increased to indicate which cyclic shift value or Walsh sequence is selected. In such instances, the DCI may correspond to a set of possible port indices instead of a single port ID. The base station may configure a new parameter in either RRC or MAC-CE to identify the port within the set of possible port indices. In some aspects, the indication may be implicitly provided based on another field within DCI, such as, for example, a time domain resource allocation (TDRA) table or an SRS cyclic shift. Some of the new configurations may be assigned to reserved values within the tables, such as for double symbols, which may lead to an indication without additional overhead. In some aspects, one or more bits may be added to the DCI to indicate the DMRS ports. The presence of the one or more extra bits may be controlled by RRC configuration. Diagram 1300 of FIG. 13 provides an example of the first configuration, with 1 DMRS symbol, and supports 4 ports. The port 1306 is identified based on the value 1302 and the CDM group(s) without data 1304. Diagram 1400 of FIG. 14 provides an example of the increased amount of ports for the first configuration, 1 DMRS symbol, that supports 12 ports. The port 1406 may be identified based on the value 1402 and the CDM group(s) without data 1404. However, the DMRS port 1406 may point to more than one port based on the value 1402 and the CDM group(s) without data 1404. In such instances, the new parameter or field in either RRC or MAC-CE may identify the port 1406. The new parameter or field within RRC or MAC-CE may be a DMRS port ID field. The identification of port 1412 may be determined based on the combination of value 1408 and CDM group(s) without data 1410, in view of the new parameter or field in either RRC or MAC-CE to identify the port 1412. Diagram 1500 of FIG. 15 provides an example of the first configuration with 2 DMRS symbols, which may provide 8 ports. The port 1506 may be identified based at least on the value 1502, the CDM group(s) without data 1504, or the number of front-load symbols 1508. In addition, the port 1514 may be identified based at least on the value 1510, the CDM group(s) without data 1512, or the number of front-load symbols 1516. Diagram 1600 of FIG. 16 provides an example of the increased amount of ports for the first configuration, 2 DMRS symbols, and supports 16 ports. The port 1606 may be identified based at least on the value 1602, the CDM group(s) without data 1604, or the number of symbols 1608. The port 1606 may point to more than one port based on the value 1602, the CDM group(s) without data 1604, or the number of symbols 1608. In such instances, the new parameter or field in either RRC or MAC-CE may identify the port 1606. The new parameter or field within RRC or MAC-CE may be a DMRS port ID field. The identification of port 1614 may be determined based at least on the value 1610, CDM group(s) without data 1612, or the number of symbols 1616, in view of the new parameter or field in either RRC or MAC-CE to identify the port 1614. The examples of FIGS. 13-16 are for the first configuration, but the disclosure is not intended to be limited to the first configuration. The disclosure may also be applied to the second configuration, having one or more DMRS symbols.

A physical resource block (PRB) bundling size may comprise 2, 4, or wideband. For a high carrier to interference and noise ratio (CINR) region, a smaller PRB bundling size (e.g., sub-RB, 1 RB) may improve downlink performance. With N frequency domain orthogonal codes (e.g., orthogonal covering codes, cyclic shifts) the code may be longer over one or more REs. It would be advantageous to have the same processing gain per port. As such, for a low or mid CINR region, larger bundle sizes may improve downlink performance. For example, for N=8 frequency domain orthogonal codes, the PRB bundling of 8 may be added as an option.

The downlink precoder granularity may comprise 2 RBs, 4 RBs, or wideband. The RRC configuration may comprise the PRB bundling types of static bundling or dynamic bundling (e.g., prb-BundlingType={“staticBundling”, “dynamicBundling”}). The DCI indicator may comprise the PRB bundling size indicator, where 1-bit may be used for dynamic bundling. When receiving PDSCH scheduled by PDCCH with DCI format 1_1 with CRC scrambled by C-RNTI, MCS-C-RNTI, or CS-RNTI, if the higher layer parameter prb-BundlingType is set to dynamic bundling, the higher layer parameters (e.g., bundleSizeSet1, bundleSizeSet2) may configure two sets of P′_{BWP,i} values, where the first set may take one or two P′_{BWP,i} values among 2 RBs, 4 RBs, or wideband, and the second set may take one P′_{BWP,i} value among 2 RBs, 4 RBs, or wideband. If the PRB bundle size indicator in the DCI is set to 1 and two values are configured for the first set of P′_{BWP,i} values as n2-wideband (corresponding to two P′_{BWP,i} values, 2 and wideband) or n4-wideband (corresponding to two P′_{BWP,i} values, 4 and wideband), the UE may use the value when receiving PDSCH scheduled by the same DCI if the scheduled PRBs are contiguous and the size of the scheduled PRBs is larger than P′_{BWP,i}^{size}/2, P′_{BWP,i} is the same as the scheduled bandwidth, otherwise P′_{BWP,i} is set to the remaining configured value of 2 or 4, respectively.

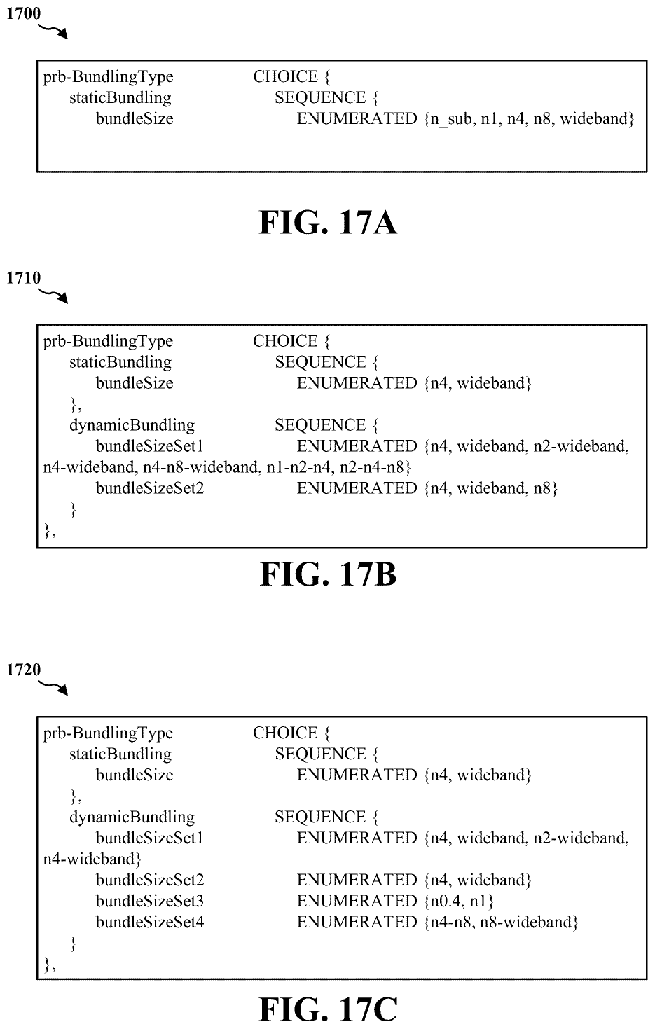

In some aspects, additional bundle sizes may be added. For example, the bundle sizes of sub-RB, 1 RB, or 8 RBs may be added. In some aspects, the bundle size of sub-RB may be fixed to one or more tones. For example, the bundle size of sub-RB may be fixed to 6 tones. In some aspects, the bundle size of sub-RB may add multiple values of n_sub, such as but not limited to 4, 6, or 8 tones. In some aspects, for example, static bundling may add bundle sizes of n_sub, n1, or n8 into the RRC configuration. For example, as shown in diagram 1700 of FIG. 17A. In some aspects, for example in dynamic bundling, more values may be added within set1 or set2. For example, bundle size set1 may add n4-n8-wideband, n1-n2-n4, or n2-n4-n8, while bundle size set2 may add n8, as shown for example in diagram 1710 of FIG. 17B. The indication of one of the value may be based on channel condition. For example, if more than 2 values (e.g., n4-n8-wideband) are set, then the value may be selected based at least on MCS and the number layers, the frequency allocation (e.g., wide or narrow), or additional bits in DCI. In some aspects, for example in dynamic bundling, additional sets may be added. For example, the additional sets may comprise bundle size set3 and bundle size set4. The additional sets may be indicated by 2 bits in DCI. For example, bundle size set3 may comprise sub-RB, 1 RB, while bundle size set4 may comprise 8 RBs, as shown for example in diagram 1720 of FIG. 17C.

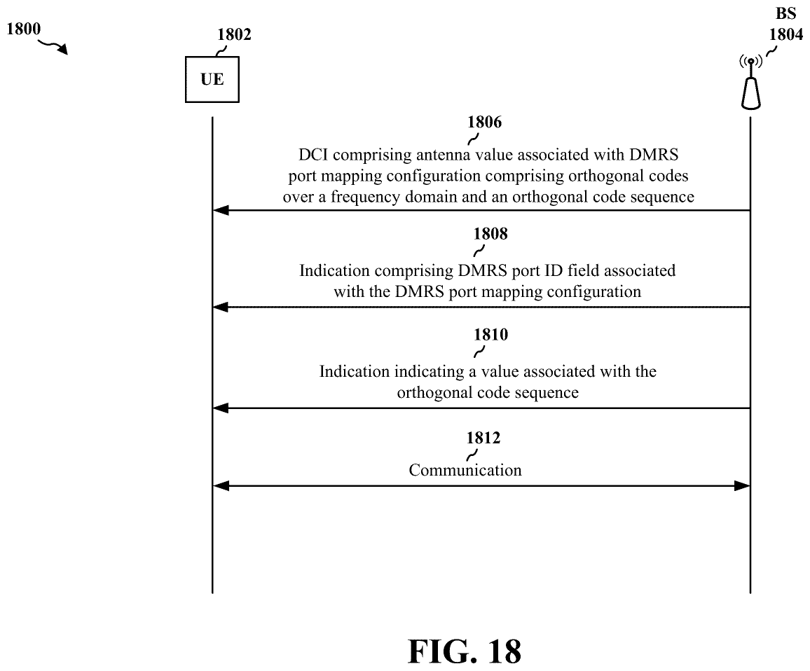

FIG. 18 is a call flow diagram 1800 of signaling between a UE 1802 and a base station 1804. The base station 1804 may be configured to provide at least one cell. The UE 1802 may be configured to communicate with the base station 1804. For example, in the context of FIG. 1, the base station 1804 may correspond to base station 102/180 and, accordingly, the cell may include a geographic coverage area 110 in which communication coverage is provided and/or small cell 102′ having a coverage area 110′. Further, a UE 1802 may correspond to at least UE 104. In another example, in the context of FIG. 3, the base station 1804 may correspond to base station 310 and the UE 1802 may correspond to UE 350.

At 1806, the base station 1804 may transmit DCI comprising an antenna value associated with a DMRS port mapping configuration. The base station 1804 may transmit the DCI comprising the antenna value associated with the DMRS port mapping configuration to the UE 1802. The UE 1802 may receive the DCI comprising the antenna value associated with the DMRS port mapping configuration from the base station 1804. The DMRS port mapping configuration may comprise orthogonal codes over a frequency domain. The DMRS port mapping configuration may comprise an orthogonal code sequence having a length (N) of orthogonal codes applied in the frequency domain. The orthogonal code sequence may have a value of N>2. In some aspects, the antenna value may also be associated with a number of DMRS CDM groups.

At 1808, the base station 1804 may transmit an indication comprising a DMRS port ID field. The base station 1804 may transmit the indication comprising the DMRS port ID field to the UE 1802. The UE 1802 may receive the indication comprising the DMRS port ID field from the base station 1804. The DMRS port ID field may be associated with the DMRS port mapping configuration. At least one of the DMRS port ID field, the orthogonal code sequence, or the antenna value may be configured to identify a DMRS port.

At 1810, the base station 1804 may provide an indication indicating a value associated with the orthogonal code sequence. The base station 1804 may provide the indication indicating the value associated with the orthogonal code sequence to the UE 1802. The UE 1802 may receive the indication indicating the value associated with the orthogonal code sequence provided by the base station 1804. The orthogonal codes may comprise at least one of orthogonal cover codes or cyclic shifting codes. The value may correspond with a row index of a Walsh matrix for the orthogonal cover codes. The value may correspond with a cyclic shift value for the cyclic shifting codes. In some aspects, the value associated with the cyclic shift value or the row index of the Walsh matrix may comprise α≥2. In some aspects, the indication indicating the value associated with the cyclic shift value or the row index of the Walsh matrix may be within the DCI. In some aspects, the indication indicating the value associated with the cyclic shift value or the row index of the Walsh matrix may be within radio resource control (RRC) signaling. In some aspects, the DCI may comprise at least one extra bit to indicate the value associated with the row index of the Walsh matrix for the orthogonal cover codes or the cyclic shift value for the cyclic shifting codes. The extra bit may correspond to the DMRS port. The presence of the at least one extra bit may be based on RRC configuration. The RRC configuration may indicate whether the at least one extra bit is present within the DCI. In some aspects, an antenna ports field within the DCI may correspond to multiple DMRS ports. In some aspects, selection of one of the multiple DMRS ports within the DCI may be indicated based on RRC configuration. In some aspects, selection of one of the multiple DMRS ports within the DCI may be indicated based on MAC-CE. In some aspects, an antenna ports field within the DCI may correspond to multiple DMRS ports for larger ranks. At least one extra bit within DCI may be associated with the DMRS ports for smaller ranks.

At 1812, the base station 1804 and the UE 1802 may communicate with each other based at least on DMRS port mapping configuration.

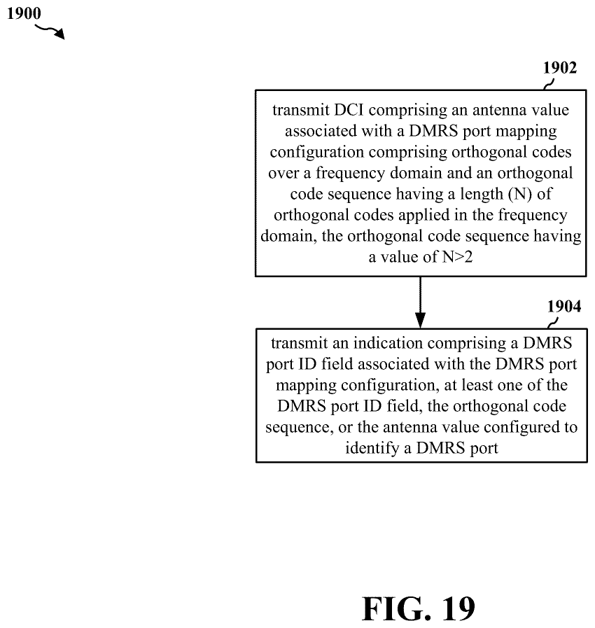

FIG. 19 is a flowchart 1900 of a method of wireless communication. The method may be performed by a base station or a component of a base station (e.g., the base station 102/180; the apparatus 2102; the baseband unit 2104, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to indicate to a DMRS port assignment via DCI.

At 1902, the base station may transmit DCI comprising an antenna value associated with a DMRS port mapping configuration. For example, 1902 may be performed by configuration component 2140 of apparatus 2102. The DMRS port mapping configuration may comprise orthogonal codes over a frequency domain. The DMRS port mapping configuration may comprise an orthogonal code sequence having a length (N) of orthogonal codes applied in the frequency domain. The orthogonal code sequence may have a value of N>2. In some aspects, the antenna value may also be associated with a number of DMRS code division multiplex (CDM) groups.

At 1904, the base station may transmit an indication comprising a DMRS port ID field. For example, 1904 may be performed by port ID component 2142 of apparatus 2102. The DMRS port ID field may be associated with the DMRS port mapping configuration. At least one of the DMRS port ID field, the orthogonal code sequence, or the antenna value may be configured to identify a DMRS port.

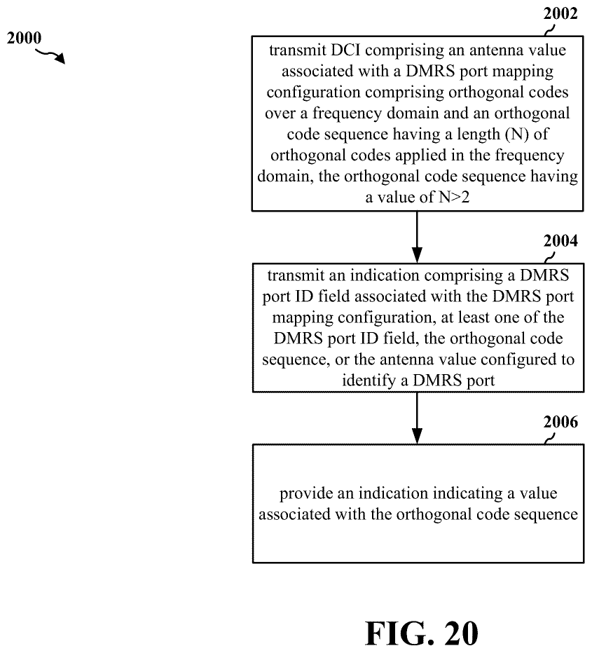

FIG. 20 is a flowchart 2000 of a method of wireless communication. The method may be performed by a base station or a component of a base station (e.g., the base station 102/180; the apparatus 2102; the baseband unit 2104, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to indicate to a DMRS port assignment using DCI.

At 2002, the base station may transmit DCI comprising an antenna value associated with a DMRS port mapping configuration. For example, 2002 may be performed by configuration component 2140 of apparatus 2102. The DMRS port mapping configuration may comprise orthogonal codes over a frequency domain. The DMRS port mapping configuration may comprise an orthogonal code sequence having a length (N) of orthogonal codes applied in the frequency domain. The orthogonal code sequence may have a value of N>2. In some aspects, the antenna value may also be associated with a number of DMRS CDM groups.

At 2004, the base station may transmit an indication comprising a DMRS port ID field. For example, 2004 may be performed by port ID component 2142 of apparatus 2102. The DMRS port ID field may be associated with the DMRS port mapping configuration. At least one of the DMRS port ID field, the orthogonal code sequence, or the antenna value may be configured to identify a DMRS port.

At 2006, the base station may provide an indication indicating a value associated with the orthogonal code sequence. For example, 2006 may be performed by value component 2144 of apparatus 2102. The orthogonal codes may comprise at least one of orthogonal cover codes or cyclic shifting codes. The value may correspond with a row index of a Walsh matrix for the orthogonal cover codes. The value may correspond with a cyclic shift value for the cyclic shifting codes. In some aspects, the value associated with the cyclic shift value or the row index of the Walsh matrix may comprise α≥2. In some aspects, the indication indicating the value associated with the cyclic shift value or the row index of the Walsh matrix may be within the DCI. In some aspects, the indication indicating the value associated with the cyclic shift value or the row index of the Walsh matrix may be within RRC signaling. In some aspects, the DCI may comprise at least one extra bit to indicate the value associated with the row index of the Walsh matrix for the orthogonal cover codes or the cyclic shift value for the cyclic shifting codes. The extra bit may correspond to the DMRS port. The presence of the at least one extra bit may be based on RRC configuration. The RRC configuration may indicate whether the at least one extra bit is present within the DCI. In some aspects, an antenna ports field within the DCI may correspond to multiple DMRS ports. In some aspects, selection of one of the multiple DMRS ports within the DCI may be indicated based on RRC configuration. In some aspects, selection of one of the multiple DMRS ports within the DCI may be indicated based on MAC-CE. In some aspects, an antenna ports field within the DCI may correspond to multiple DMRS ports for larger ranks. At least one extra bit within DCI may be associated with the DMRS ports for smaller ranks.

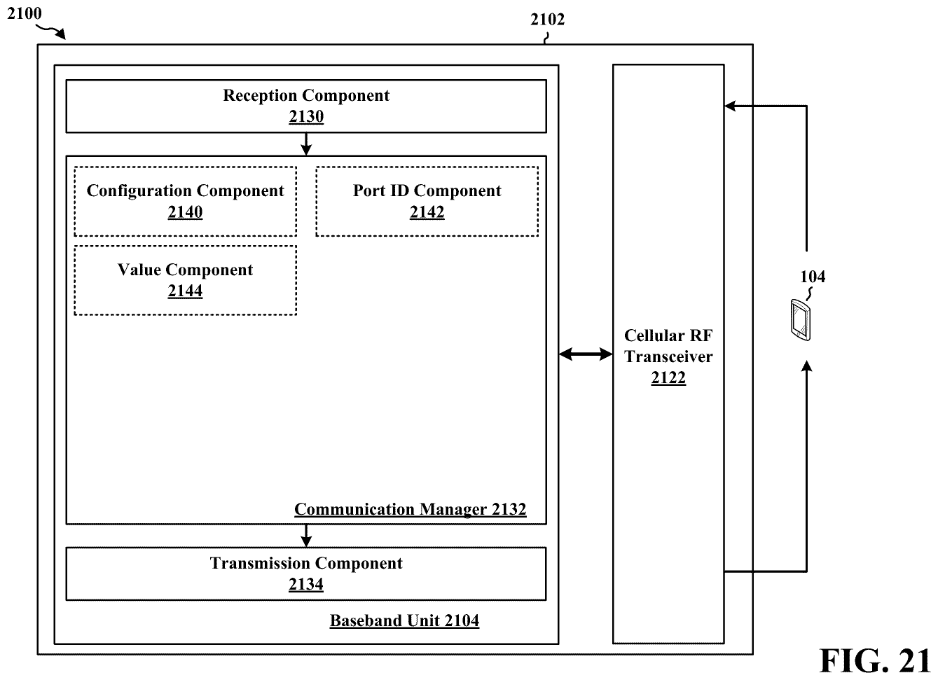

FIG. 21 is a diagram 2100 illustrating an example of a hardware implementation for an apparatus 2102. The apparatus 2102 may be a base station, a component of a base station, or may implement base station functionality. In some aspects, the apparatus 2102 may include a baseband unit 2104. The baseband unit 2104 may communicate through a cellular RF transceiver 2122 with the UE 104. The baseband unit 2104 may include a computer-readable medium/memory. The baseband unit 2104 is responsible for general processing, including the execution of software stored on the computer-readable medium/memory. The software, when executed by the baseband unit 2104, causes the baseband unit 2104 to perform the various functions described supra. The computer-readable medium/memory may also be used for storing data that is manipulated by the baseband unit 2104 when executing software. The baseband unit 2104 further includes a reception component 2130, a communication manager 2132, and a transmission component 2134. The communication manager 2132 includes the one or more illustrated components. The components within the communication manager 2132 may be stored in the computer-readable medium/memory and/or configured as hardware within the baseband unit 2104. The baseband unit 2104 may be a component of the base station 310 and may include the memory 376 and/or at least one of the TX processor 316, the RX processor 370, and the controller/processor 375.

The communication manager 2132 includes a configuration component 2140 that may transmit DCI comprising an antenna value associated with a DMRS port mapping configuration, e.g., as described in connection with 1902 of FIG. 19 or 2002 of FIG. 20. The communication manager 2132 further includes a port ID component 2142 that may transmit an indication comprising a DMRS port ID field, e.g., as described in connection with 1904 of FIG. 19 or 2004 of FIG. 20. The communication manager 2132 further includes a value component 2144 that may provide an indication indicating a value associated with the orthogonal code sequence, e.g., as described in connection with 2006 of FIG. 20.

The apparatus may include additional components that perform each of the blocks of the algorithm in the flowcharts of FIGS. 19 and 20. As such, each block in the flowcharts of FIGS. 19 and 20 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2102 may include a variety of components configured for various functions. In one configuration, the apparatus 2102, and in particular the baseband unit 2104, includes means for transmitting DCI comprising an antenna value associated with a DMRS port mapping configuration. The DMRS port mapping configuration comprising orthogonal codes over a frequency domain and an orthogonal code sequence having a length (N) of orthogonal codes applied in the frequency domain. The orthogonal code sequence having a value of N>2. The apparatus includes means for transmitting an indication comprising a DMRS port ID field associated with the DMRS port mapping configuration. At least one of the DMRS port ID field, the orthogonal code sequence, or the antenna value configured to identify a DMRS port. The apparatus further includes means for providing an indication indicating a value associated with the orthogonal code sequence. The orthogonal codes comprise at least one of orthogonal cover codes or cyclic shifting codes. The value corresponds with a row index of a Walsh matrix for the orthogonal cover codes. The value corresponds with a cyclic shift value for the cyclic shifting codes. The means may be one or more of the components of the apparatus 2102 configured to perform the functions recited by the means. As described supra, the apparatus 2102 may include the TX Processor 316, the RX Processor 370, and the controller/processor 375. As such, in one configuration, the means may be the TX Processor 316, the RX Processor 370, and the controller/processor 375 configured to perform the functions recited by the means.

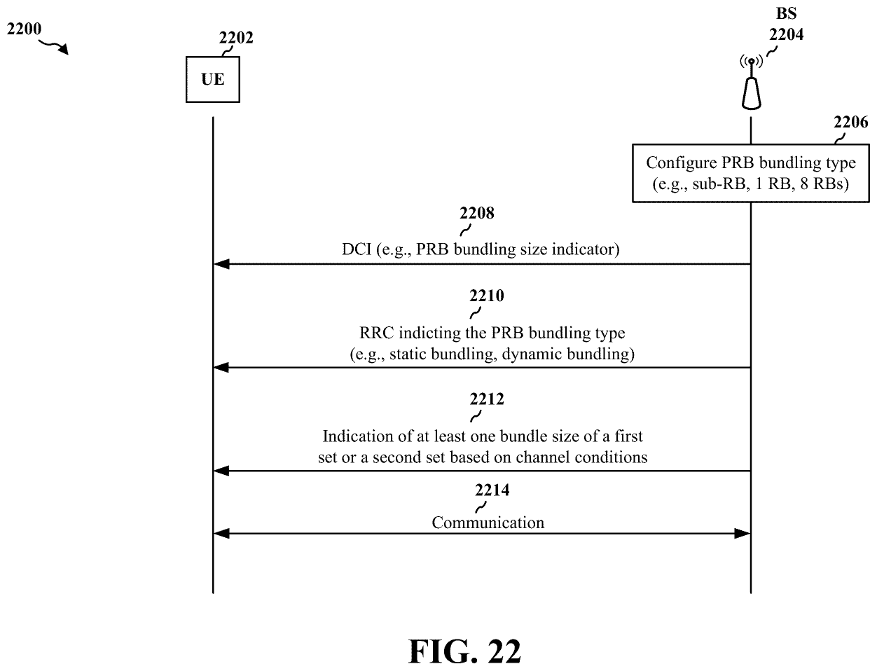

FIG. 22 is a call flow diagram 2200 of signaling between a UE 2202 and a base station 2204. The base station 2204 may be configured to provide at least one cell. The UE 2202 may be configured to communicate with the base station 2204. For example, in the context of FIG. 1, the base station 2204 may correspond to base station 102/180 and, accordingly, the cell may include a geographic coverage area 110 in which communication coverage is provided and/or small cell 102′ having a coverage area 110′. Further, a UE 2202 may correspond to at least UE 104. In another example, in the context of FIG. 3, the base station 2204 may correspond to base station 310 and the UE 2202 may correspond to UE 350.

At 2206, the base station 2204 may configure a PRB bundling type. The PRB bundling type may comprise bundle sizes of sub-RB, 1 RB, or 8 RBs. In some aspects, a bundle size of sub-RB may be fixed to n tones, where n>0. In some aspects, the bundle size of the sub-RB may be fixed to 6 tones. In some aspects, a bundle size of sub-RB may comprise a plurality of values of n_sub. The n_sub may comprise multiple values of n tones, where n>0.

At 2208, the base station 2204 may transmit DCI comprising a PRB bundling size indicator. The base station 2204 may transmit the DCI comprising the PRB bundling size indicator to the UE 2202. The UE 2202 may receive the DCI from the base station 2204. The PRB bundling size indicator may indicate the PRB bundling type configured the base station 2204.

At 2210, the base station 2204 may transmit RRC signaling indicating the PRB bundling type. The base station 2204 may transmit the RRC signaling indicating the PRB bundling type to the UE 2202. The UE 2202 may receive the RRC signaling from the base station 2204. The PRB bundling type may comprise static bundling or dynamic bundling. In some aspects, the RRC signaling may indicate that the PRB bundling type comprises static bundling. In such aspects, the static bundling may comprise the bundle sizes of n_sub, n1, n4, n8, or wideband. In some aspects, the RRC signaling may indicate that the PRB bundling type comprises the dynamic bundling. In such aspects, the dynamic bundling may comprise a first set of bundle sizes and a second set of bundle sizes. In some aspects, the first set of bundle sizes may comprise at least multiple values of n tones, where n>0. The second set of bundle sizes may comprise at least one value of n tones, where n>0. In some aspects, the dynamic bundling may further comprise a plurality of sets of bundle sizes. The plurality of sets may be indicated via DCI. In some aspects, wherein the DCI may comprise at least one bit to indicate the plurality of sets. In some aspects, at least one of the plurality of sets of bundle sizes may comprise multiple values of tones, where n>0. At least another one of the plurality of sets of bundle sizes may comprise multiple values of tones, where n>0. In some aspects, the first set of bundle sizes may comprise at least multiple values of n tones, where n>0. The second set of bundle sizes may comprise at least one value of n tones, where n>0. The dynamic bundling may further comprise a plurality of sets of bundle sizes. The plurality of sets may be indicated via at least one bit with the DCI.

At 2212, the base station 2204 may, in aspects where the dynamic bundling comprises the first set of bundle sizes and the second set of bundle sizes, transmit an indication of at least one of the bundle sizes of the first set or the second set based on channel conditions. In some aspects, if more than two values are set within the first set or the second set, then the value of the at least one of the bundle sizes may be selected based on at least one of modulation and coding scheme (MCS) and a number of layers, a frequency allocation, or based additional bits in DCI.

At 2214, the base station 2204 and the UE 2202 may communicate with each other based at least on the PRB bundling type and the PRB bundling size.

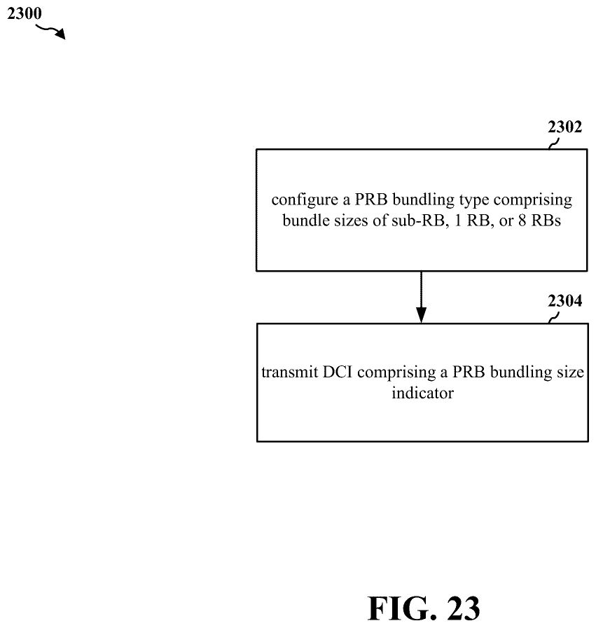

FIG. 23 is a flowchart 2300 of a method of wireless communication. The method may be performed by a base station or a component of a base station (e.g., the base station 102/180; the apparatus 2502; the baseband unit 2504, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to indicate a PRB bundle size via DCI.

At 2302, the base station may configure a PRB bundling type. For example, 2302 may be performed by PRB bundling component 2540 of apparatus 2502. The PRB bundling type may comprise bundle sizes of sub-RB, 1 RB, or 8 RBs. In some aspects, a bundle size of sub-RB may be fixed to n tones, where n>0. In some aspects, the bundle size of the sub-RB may be fixed to 6 tones. In some aspects, a bundle size of sub-RB may comprise a plurality of values of n_sub. The n_sub may comprise multiple values of n tones, where n>0.

At 2304, the base station may transmit DCI comprising a PRB bundling size indicator. For example, 2304 may be performed by bundle size component 2542 of apparatus 2502.

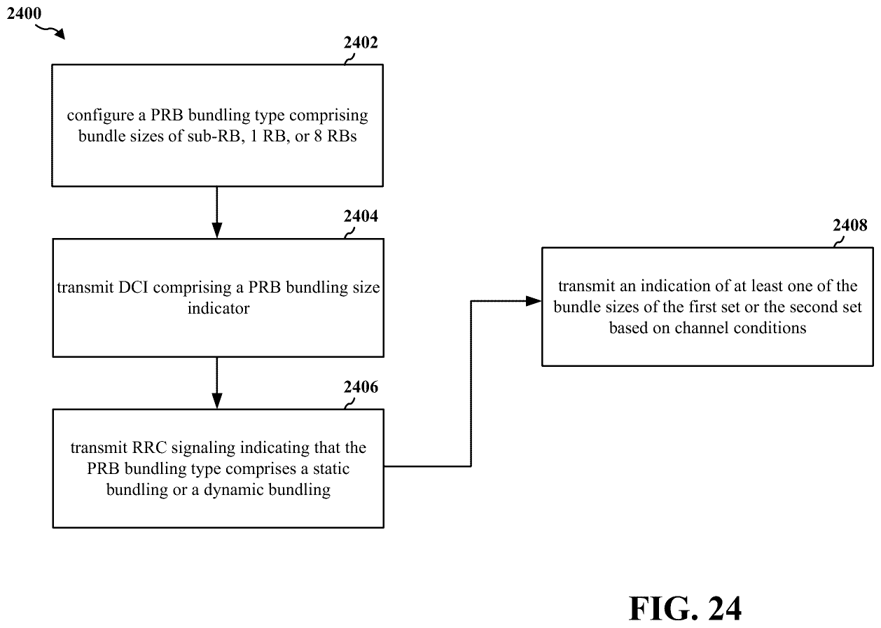

FIG. 24 is a flowchart 2400 of a method of wireless communication. The method may be performed by a base station or a component of a base station (e.g., the base station 102/180; the apparatus 2502; the baseband unit 2504, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to indicate a PRB bundle size via DCI.

At 2402, the base station may configure a PRB bundling type. For example, 2402 may be performed by PRB bundling component 2540 of apparatus 2502. The PRB bundling type may comprise bundle sizes of sub-RB, 1 RB, or 8 RBs. In some aspects, a bundle size of sub-RB may be fixed to n tones, where n>0. In some aspects, the bundle size of the sub-RB may be fixed to 6 tones. In some aspects, a bundle size of sub-RB may comprise a plurality of values of n_sub. The n_sub may comprise multiple values of n tones, where n>0.

At 2404, the base station may transmit DCI comprising a PRB bundling size indicator. For example, 2404 may be performed by bundle size component 2542 of apparatus 2502.

At 2406, the base station may transmit RRC signaling indicating that the PRB bundling type comprises a static bundling or a dynamic bundling. For example, 2406 may be performed by bundle type component 2544 of apparatus 2502. In some aspects, the RRC signaling may indicate that the PRB bundling type comprises static bundling. In such aspects, the static bundling may comprise the bundle sizes of n_sub, n1, n4, n8, or wideband. In some aspects, the RRC signaling may indicate that the PRB bundling type comprises the dynamic bundling. In such aspects, the dynamic bundling may comprise a first set of bundle sizes and a second set of bundle sizes. In some aspects, the first set of bundle sizes may comprise at least multiple values of n tones, where n>0. The second set of bundle sizes may comprise at least one value of n tones, where n>0. In some aspects, the dynamic bundling may further comprise a plurality of sets of bundle sizes. The plurality of sets may be indicated via DCI. In some aspects, wherein the DCI may comprise at least one bit to indicate the plurality of sets. In some aspects, at least one of the plurality of sets of bundle sizes may comprise multiple values of tones, where n>0. At least another one of the plurality of sets of bundle sizes may comprise multiple values of tones, where n>0. In some aspects, the first set of bundle sizes may comprise at least multiple values of n tones, where n>0. The second set of bundle sizes may comprise at least one value of n tones, where n>0. The dynamic bundling may further comprise a plurality of sets of bundle sizes. The plurality of sets may be indicated via at least one bit with the DCI.

At 2408, the base station may transmit an indication of at least one of the bundle sizes of the first set or the second set based on channel conditions. For example, 2408 may be performed by bundle size component 2542 of apparatus 2502. In some aspects, if more than two values are set within the first set or the second set, then the value of the at least one of the bundle sizes may be selected based on at least one of MCS and a number of layers, a frequency allocation, or based additional bits in DCI.

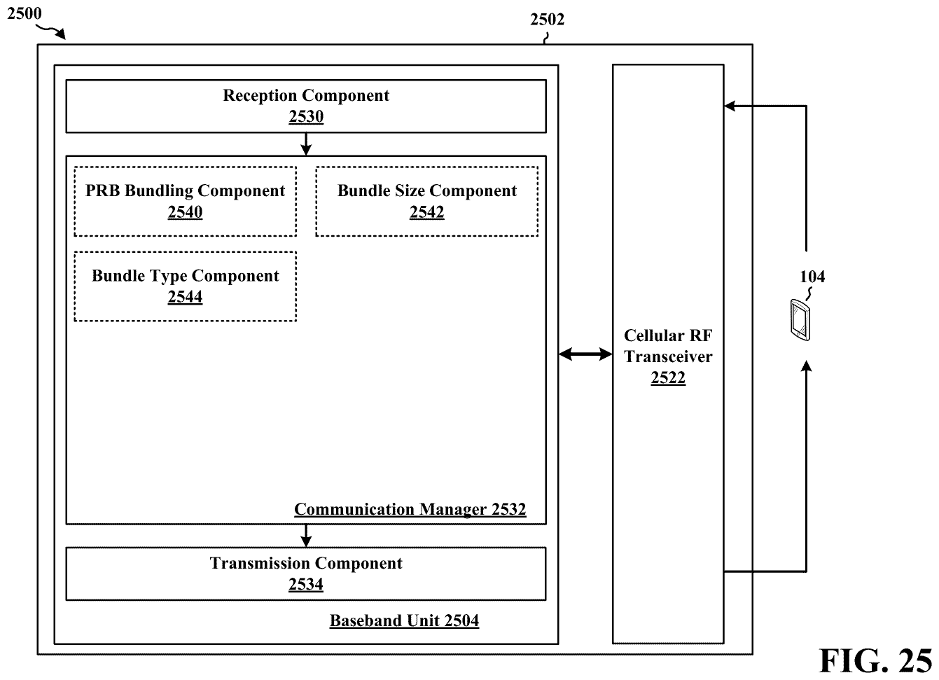

FIG. 25 is a diagram 2500 illustrating an example of a hardware implementation for an apparatus 2502. The apparatus 2502 may be a base station, a component of a base station, or may implement base station functionality. In some aspects, the apparatus 2502 may include a baseband unit 2504. The baseband unit 2504 may communicate through a cellular RF transceiver 2522 with the UE 104. The baseband unit 2504 may include a computer-readable medium/memory. The baseband unit 2504 is responsible for general processing, including the execution of software stored on the computer-readable medium/memory. The software, when executed by the baseband unit 2504, causes the baseband unit 2504 to perform the various functions described supra. The computer-readable medium/memory may also be used for storing data that is manipulated by the baseband unit 2504 when executing software. The baseband unit 2504 further includes a reception component 2530, a communication manager 2532, and a transmission component 2534. The communication manager 2532 includes the one or more illustrated components. The components within the communication manager 2532 may be stored in the computer-readable medium/memory and/or configured as hardware within the baseband unit 2504. The baseband unit 2504 may be a component of the base station 310 and may include the memory 376 and/or at least one of the TX processor 316, the RX processor 370, and the controller/processor 375.

The communication manager 2532 includes a PRB bundling component 2540 that may configure a PRB bundling type, e.g., as described in connection with 2302 of FIGS. 23 and 2402 of FIG. 24. The communication manager 2532 further includes a bundle size component 2542 that may transmit DCI comprising a PRB bundling size indicator, e.g., as described in connection with 2304 of FIG. 23 and 2404 of FIG. 24. The bundle size component 2542 may be further configured to transmit an indication of at least one of the bundle sizes of the first set or the second set based on channel conditions, e.g., as described in connection with 2408 of FIG. 24. The communication manager 2532 further includes a bundle type component 2544 that may transmit RRC signaling indicating that the PRB bundling type comprises a static bundling or a dynamic bundling, e.g., as described in connection with 2406 of FIG. 24.

The apparatus may include additional components that perform each of the blocks of the algorithm in the flowcharts of FIGS. 23 and 23. As such, each block in the flowcharts of FIGS. 23 and 23 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2502 may include a variety of components configured for various functions. In one configuration, the apparatus 2502, and in particular the baseband unit 2504, includes means for configuring a PRB bundling type comprising bundle sizes of sub-RB, 1 RB, or 8 RBs. The apparatus includes means for transmitting DCI comprising a PRB bundling size indicator. The apparatus further includes means for transmitting RRC signaling indicating that the PRB bundling type comprises a static bundling. The static bundling comprises the bundle sizes of n_sub, n1, n4, n8, or wideband. The apparatus further includes means for transmitting RRC signaling indicating that the PRB bundling type comprises a dynamic bundling. The dynamic bundling comprises a first set of bundle sizes and a second set of bundle sizes. The apparatus further includes means for transmitting an indication of at least one of the bundle sizes of the first set or the second set based on channel conditions. The means may be one or more of the components of the apparatus 2502 configured to perform the functions recited by the means. As described supra, the apparatus 2502 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a base station including at least one processor coupled to a memory and configured to transmit downlink control information (DCI) comprising an antenna value associated with a demodulation reference signal (DMRS) port mapping configuration, the DMRS port mapping configuration comprising orthogonal codes over a frequency domain and an orthogonal code sequence having a length (N) of orthogonal codes applied in the frequency domain, wherein the orthogonal code sequence having a value of N>2; and transmit an indication comprising a DMRS port identifier (ID) field associated with the DMRS port mapping configuration, wherein at least one of the DMRS port ID field, the orthogonal code sequence, or the antenna value configured to identify a DMRS port.

Aspect 2 is the apparatus of aspect 1, further includes that a transceiver coupled to the at least one processor.

Aspect 3 is the apparatus of any of aspects 1 and 2, further includes that the antenna value is also associated with a number of DMRS CDM groups.

Aspect 4 is the apparatus of any of aspects 1-3, further includes that the at least one processor is further configured to provide an indication indicating a value associated with the orthogonal code sequence, wherein the orthogonal codes comprise at least one of orthogonal cover codes or cyclic shifting codes, wherein the value corresponds with a row index of a Walsh matrix for the orthogonal cover codes, wherein the value corresponds with a cyclic shift value for the cyclic shifting codes.

Aspect 5 is the apparatus of any of aspects 1-4, further includes that the value associated with the cyclic shift value or the row index of the Walsh matrix comprises α≥2.

Aspect 6 is the apparatus of any of aspects 1-5, further includes that the indication indicating the value associated with the cyclic shift value or the row index of the Walsh matrix is within the DCI.

Aspect 7 is the apparatus of any of aspects 1-6, further includes that the indication indicating the value associated with the cyclic shift value or the row index of the Walsh matrix is within RRC signaling.

Aspect 8 is the apparatus of any of aspects 1-7, further includes that the DCI comprises at least one extra bit to indicate the value associated with the row index of the Walsh matrix for the orthogonal cover codes or the cyclic shift value for the cyclic shifting codes, wherein the at least one extra bit corresponds to the DMRS port.

Aspect 9 is the apparatus of any of aspects 1-8, further includes that presence of the at least one extra bit is based on RRC configuration, wherein the RRC configuration indicates whether the at least one extra bit is present within the DCI.

Aspect 10 is the apparatus of any of aspects 1-9, further includes that an antenna ports field within the DCI corresponds to multiple DMRS ports.

Aspect 11 is the apparatus of any of aspects 1-10, further includes that selection of one of the multiple DMRS ports within the DCI is indicated based on RRC configuration.

Aspect 12 is the apparatus of any of aspects 1-11, further includes that selection of one of the multiple DMRS ports within the DCI is indicated based on MAC-CE.

Aspect 13 is the apparatus of any of aspects 1-12, further includes that an antenna ports field within the DCI corresponds to multiple DMRS ports for larger ranks, wherein at least one extra bit within DCI is associated with the DMRS ports for smaller ranks.

Aspect 14 is a method of wireless communication for implementing any of aspects 1-13.

Aspect 15 is an apparatus for wireless communication including means for implementing any of aspects 1-13.

Aspect 16 is a computer-readable medium storing computer executable code, where the code when executed by a processor causes the processor to implement any of aspects 1-13.

Aspect 17 is an apparatus for wireless communication at a base station including at least one processor coupled to a memory and configured to configure a physical resource block (PRB) bundling type comprising bundle sizes of sub-resource block (RB), 1 RB, or 8 RBs; and transmit downlink control information (DCI) comprising a PRB bundling size indicator.

Aspect 18 is the apparatus of aspect 17, further including a transceiver coupled to the at least one processor.

Aspect 19 is the apparatus of any of aspects 17 and 18, further includes that a bundle size of sub-RB is fixed to n tones, where n>0.

Aspect 20 is the apparatus of any of aspects 17-19, further includes that the bundle size of the sub-RB is fixed to 6 tones.

Aspect 21 is the apparatus of any of aspects 17-20, further includes that a bundle size of sub-RB comprises a plurality of values of n_sub, wherein n_sub comprises multiple values of n tones, where n>0.

Aspect 22 is the apparatus of any of aspects 17-21, further includes that the at least one processor is further configured to transmit RRC signaling indicating that the PRB bundling type comprises a static bundling, wherein the static bundling comprises the bundle sizes of n_sub, n1, n4, n8, or wideband.

Aspect 23 is the apparatus of any of aspects 17-22, further includes that the at least one processor is further configured to transmit RRC signaling indicating that the PRB bundling type comprises a dynamic bundling, wherein the dynamic bundling comprises a first set of bundle sizes and a second set of bundle sizes.

Aspect 24 is the apparatus of any of aspects 17-23, further includes that the first set of bundle sizes comprises at least multiple values of n tones, where n>0, wherein the second set of bundle sizes comprises at least one value of n tones, where n>0.

Aspect 25 is the apparatus of any of aspects 17-24, further includes that the at least one processor is further configured to transmit an indication of at least one of the bundle sizes of the first set or the second set based on channel conditions.

Aspect 26 is the apparatus of any of aspects 17-25, further includes that if more than two values are set within the first set or the second set, then the value of the at least one of the bundle sizes is selected based on at least one of MCS and a number of layers, a frequency allocation, or based additional bits in DCI.

Aspect 27 is the apparatus of any of aspects 17-26, further includes that the dynamic bundling further comprises a plurality of sets of bundle sizes, wherein the plurality of sets are indicated via DCI.

Aspect 28 is the apparatus of any of aspects 17-27, further includes that the DCI comprises at least one bit to indicate the plurality of sets.

Aspect 29 is the apparatus of any of aspects 17-28, further includes that at least one of the plurality of sets of bundle sizes comprises multiple values of tones, where n>0, wherein at least another one of the plurality of sets of bundle sizes comprises multiple values of tones, where n>0.

Aspect 30 is the apparatus of any of aspects 17-29, further includes that the first set of bundle sizes comprises at least multiple values of n tones, where n>0, wherein the second set of bundle sizes comprises at least one value of n tones, where n>0, wherein the dynamic bundling further comprises a plurality of sets of bundle sizes, wherein the plurality of sets are indicated via at least one bit with the DCI.

Aspect 31 is a method of wireless communication for implementing any of aspects 17-30.

Aspect 32 is an apparatus for wireless communication including means for implementing any of aspects 17-30.

Aspect 33 is a computer-readable medium storing computer executable code, where the code when executed by a processor causes the processor to implement any of aspects 17-30.

What is claimed is:

1. An apparatus for wireless communication at a base station, comprising:
a memory; and
at least one processor coupled to the memory and configured to:
transmit downlink control information (DCI) comprising an antenna value associated with a demodulation reference signal (DMRS) port mapping configuration, the DMRS port mapping configuration comprising orthogonal codes over a frequency domain and an orthogonal code sequence having a length (N) of orthogonal codes applied in the frequency domain, wherein the orthogonal code sequence having a value of N>2; and
transmit an indication comprising a DMRS port identifier (ID) field associated with the DMRS port mapping configuration, wherein at least one of the DMRS port ID field, the orthogonal code sequence, or the antenna value configured to identify a DMRS port.

2. The apparatus of claim 1, further comprising a transceiver coupled to the at least one processor.

3. The apparatus of claim 1, wherein the antenna value is also associated with a number of DMRS code division multiplex (CDM) groups.

4. The apparatus of claim 1, wherein the at least one processor is further configured to:
provide an indication indicating a value associated with the orthogonal code sequence, wherein the orthogonal codes comprise at least one of orthogonal cover codes or cyclic shifting codes, wherein the value corresponds with a row index of a Walsh matrix for the orthogonal cover codes, wherein the value corresponds with a cyclic shift value for the cyclic shifting codes.

5. The apparatus of claim 4, wherein the value associated with the cyclic shift value or the row index of the Walsh matrix comprises α≥2.

6. The apparatus of claim 4, wherein the indication indicating the value associated with the cyclic shift value or the row index of the Walsh matrix is within the DCI.

7. The apparatus of claim 4, wherein the indication indicating the value associated with the cyclic shift value or the row index of the Walsh matrix is within radio resource control (RRC) signaling.

8. The apparatus of claim 4, wherein the DCI comprises at least one extra bit to indicate the value associated with the row index of the Walsh matrix for the orthogonal cover codes or the cyclic shift value for the cyclic shifting codes, wherein the at least one extra bit corresponds to the DMRS port.

9. The apparatus of claim 8, wherein presence of the at least one extra bit is based on radio resource control (RRC) configuration, wherein the RRC configuration indicates whether the at least one extra bit is present within the DCI.

10. The apparatus of claim 8, wherein an antenna ports field within the DCI corresponds to multiple DMRS ports.

11. The apparatus of claim 10, wherein selection of one of the multiple DMRS ports within the DCI is indicated based on radio resource control (RRC) configuration.

12. The apparatus of claim 10, wherein selection of one of the multiple DMRS ports within the DCI is indicated based on medium access control (MAC) control element (CE) (MAC-CE).

13. The apparatus of claim 4, wherein an antenna ports field within the DCI corresponds to multiple DMRS ports for larger ranks, wherein at least one extra bit within the DCI is associated with the DMRS ports for smaller ranks.

14. A method of wireless communication at a base station, comprising:
transmitting downlink control information (DCI) comprising an antenna value associated with a demodulation reference signal (DMRS) port mapping configuration, the DMRS port mapping configuration comprising orthogonal codes over a frequency domain and an orthogonal code sequence having a length (N) of orthogonal codes applied in the frequency domain, wherein the orthogonal code sequence having a value of N>2; and
transmitting an indication comprising a DMRS port identifier (ID) field associated with the DMRS port mapping configuration, wherein at least one of the DMRS port ID field, the orthogonal code sequence, or the antenna value configured to identify a DMRS port.

15. The method of claim 14, further comprising:
providing an indication indicating a value associated with the orthogonal code sequence, wherein the orthogonal codes comprise at least one of orthogonal cover codes or cyclic shifting codes, wherein the value corresponds with a row index of a Walsh matrix for the orthogonal cover codes, wherein the value corresponds with a cyclic shift value for the cyclic shifting codes.

16. An apparatus for wireless communication at a base station, comprising:
a memory; and
at least one processor coupled to the memory and configured to:
configure a physical resource block (PRB) bundling type comprising bundle sizes of sub-resource block (RB), 1 RB, or 8 RBs; and
transmit downlink control information (DCI) comprising a PRB bundling size indicator.

17. The apparatus of claim 16, further comprising a transceiver coupled to the at least one processor.

18. The apparatus of claim 16, wherein a bundle size of sub-RB is fixed to n tones, where n>0.

19. The apparatus of claim 18, wherein the bundle size of the sub-RB is fixed to 6 tones.

20. The apparatus of claim 16, wherein a bundle size of sub-RB comprises a plurality of values of n_sub, wherein the n_sub comprises multiple values of n tones, where n>0.

21. The apparatus of claim 16, wherein the at least one processor is further configured to:
transmit radio resource control (RRC) signaling indicating that the PRB bundling type comprises a static bundling, wherein the static bundling comprises the bundle sizes of n_sub, n1, n4, n8, or wideband.

22. The apparatus of claim 16, wherein the at least one processor is further configured to:
transmit radio resource control (RRC) signaling indicating that the PRB bundling type comprises a dynamic bundling, wherein the dynamic bundling comprises a first set of bundle sizes and a second set of bundle sizes.

23. The apparatus of claim 22, wherein the first set of bundle sizes comprises at least multiple values of n tones, where n>0, wherein the second set of bundle sizes comprises at least one value of n tones, where n>0.

24. The apparatus of claim 23, wherein the at least one processor is further configured to:
transmit an indication of at least one of the bundle sizes of the first set or the second set based on channel conditions.

25. The apparatus of claim 24, wherein if more than two values are set within the first set or the second set, then the value of the at least one of the bundle sizes is selected based on at least one of modulation and coding scheme (MCS) and a number of layers, a frequency allocation, or based additional bits in the DCI.

26. The apparatus of claim 22, wherein the dynamic bundling further comprises a plurality of sets of bundle sizes, wherein the plurality of sets are indicated via the DCI.

27. The apparatus of claim 26, wherein the DCI comprises at least one bit to indicate the plurality of sets.

28. The apparatus of claim 26, wherein at least one of the plurality of sets of bundle sizes comprises multiple values of tones, where n>0, wherein at least another one of the plurality of sets of bundle sizes comprises multiple values of tones, where n>0.

29. The apparatus of claim 22, wherein the first set of bundle sizes comprises at least multiple values of n tones, where n>0, wherein the second set of bundle sizes comprises at least one value of n tones, where n>0, wherein the dynamic bundling further comprises a plurality of sets of bundle sizes, wherein the plurality of sets are indicated via at least one bit with the DCI.

30. A method of wireless communication at a base station, comprising:
configuring a physical resource block (PRB) bundling type comprising bundle sizes of sub-resource block (RB), 1 RB, or 8 RBs; and
transmitting downlink control information (DCI) comprising a PRB bundling size indicator.
